(19) United States
(12) Patent Application Publication
(10) Pub. No.: US 2002/0152424 A1
(43) Pub. Date: Oct. 17, 2002

(54) Computer system reinitiation method

(76) Inventors: Yuri Hiraiwa, Sagamihara (JP); Hirofumi Nagasuka, Sagamihara (JP); Akira Otsuji, Yokohama (JP)

Correspondence Address: MCDERMOTT, WILL & EMERY, 600 13th Street, N.W., Washington, DC, 20005-3096, US

(21) Appl. No.: 10/078,268

(22) Filed: Feb. 20, 2002

(30) Foreign Application Priority Data
Feb. 28, 2001 (JP) 2001-053457

(51) Int. Cl. H04L 1/22

(52) U.S. Cl. 714/15; 714/1

(57) ABSTRACT

To prepare for re-initiation of a computer system, a content of a main memory after system initiation is saved in a save area of a main memory, The content of the save area is restored to the main memory when re-initiation.

### BACKGROUND OF THE INVENTION

This invention relates to a technology for improving a processing speed of an initialization processing in a computer system.

High reliability is strongly required for a basic system. Even when any system-down develops due to a software fault, for example, the system must be reinitiated immediately to restore a business as soon as possible.

To initiate a computer system, however, a series of initializing processing is necessary such as an initializing processing for loading a necessary program to a main memory, an initializing processing for permitting execution of an OS and an initialization processing for permitting execution of an application. Such an initialization processing needs a long time to conduct input/output operations for reading necessary data to and from an external memory, to arrange an OS management table on a main memory, and so forth.

To speed up this initialization processing, JP-A-3-278126 discloses a technology that copies in advance information of a main memory after the initialization processing to a copy memory such as an external memory, returns this copy information to the main memory at the time of re-initiation and uses it in place of the initialization processing. A back-up memory having the same capacity as that of the main memory used in the system is provided, and a copy of the content of the main memory after the initialization processing is prepared. When the system is reinitiated, the content is copied from this copy to the main memory so that re-initiation can be made quickly.

The technology described in JP-A-3-278126 needs the copy memory having the same capacity as that of the main memory to copy the whole information of the main memory.

Because the area of the main memory that is not actually used is copied and restored upon re-initiation, too, an unnecessary processing is conducted.

As the scale of the computer system becomes great, the capacity of the main memory mounted tends to increase. In this case, the problem described above invites the increase of the system cost and extension of the system re-initiation time.

### SUMMARY OF THE INVENTION

To solve the problem described above, the present invention provides a method that conducts copying and restoration of a main memory for only the main memory that is now in use.

A main-memory copying portion, a main-memory restoring portion and an activation selecting portion are provided to a system initiation portion in addition to a conventional initialization processing portion.

The main-memory copying portion copies only a predetermined main memory area allocated after initiation of the system as its object. An area to be copied is dynamically secured during copying. In consequence, the copied area can be limited to a necessary capacity.

The main-memory restoring portion restores the area copied by the main-memory copying portion to the main memory. Consequently, the system can be re-initiated at a high speed irrespective of the main memory capacity.

When the system is re-initiated, the activation selecting portion operates the main-memory restoring portion in place of the initialization processing portion when designated at the time of system initiation.

Other objects, features and advantages of the invention will become apparent from the following description of the embodiments of the invention taken in conjunction with the accompanying drawings.

### BRIEF DESCRITPION OF THE DRAWINGS

FIG. 1 is a structural view of a computer system for accomplishing a system activation method according to the present invention;

FIG. 2 is an explanatory view of a save area;

FIG. 3 is an explanatory view of a correspondence table;

FIG. 4 is an explanatory view of a real page management table entry;

FIG. 5 is a flow chart useful for explaining a processing of an activation selecting portion;

FIG. 6 is a flowchart useful for explaining a processing of a main-memory copying portion;

FIG. 7 is a flowchart useful for explaining a processing of a main-memory restoring portion;

FIG. 8 is a structural view of another computer system for accomplishing a system activation method according to the present invention;

FIG. 9 is a flowchart useful for explaining a new processing of the main-memory copying portion; and

FIG. 10 is a flowchart useful for explaining a new processing of the main-memory restoring portion.

### DESCRIPTION OF THE EMBODIMENTS

Hereinafter, preferred embodiments of the present invention will be explained in detail with reference to the accompanying drawings.

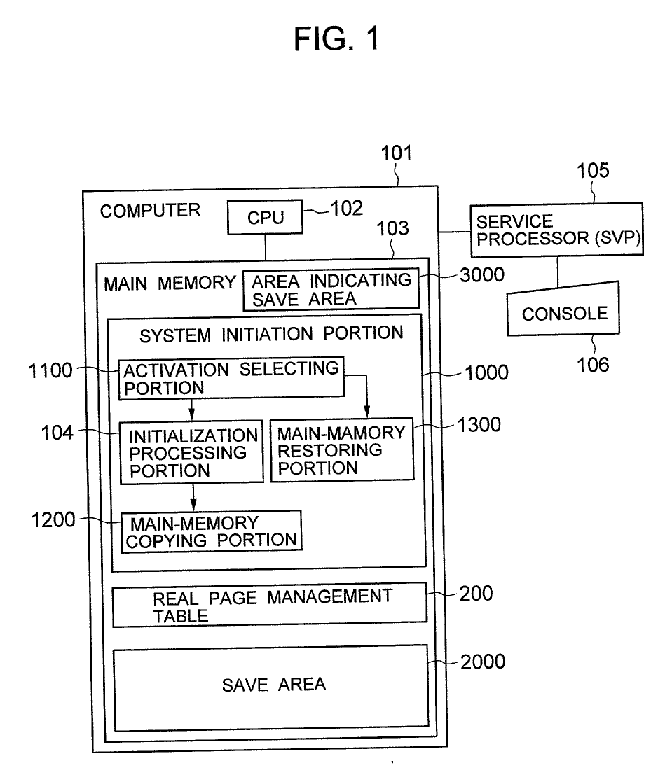

A first embodiment will be explained with reference to FIGS. 1 to 7.

FIG. 1 is a structural view of a computer system according to this embodiment. A computer 101 includes a CPU 102 and a main memory 103.

The main memory 103 includes a real page management table 200 for managing a real page, a system initiation portion 1000 for conducting system activation, a save area 2000 secured for system activation and an area indicating save area 3000 for indicating an arrangement position of the save area 2000 on the main memory 103. The area 3000 stores a pointer indicating a leading address of the area 2000 and a size of the area, for example.

The system initiation portion 1000 includes an initialization processing portion 104 for executing a conventional system activation processing, an activation selecting portion 1100 for distinguishing a system initiation from a system re-initiation, a main-memory copying portion 1200 and a main-memory restoring portion 1300.

The initialization processing portion 104 executes initialization for writing 0 to an area of the main memory 103, loads a load module necessary for OS activation from an external memory device, generates a management table in accordance with the parameters designated by the external memory device, executes the initialization processing so that the OS can be executed, and further executes the initialization processing so that an application can be executed.

A service processor (SVP) 105 for executing designation about activation is connected to this system. The SVP 105 includes a console 106 for allowing an operator to input and output data.

After the initialization processing portion 104 executes a conventional system activation processing, the main-memory copying portion 1200 copies the content of the main memory 103 to the save area 2000. In consequence, the content of the main memory 103 after the initialization processing is saved in the save area. When activation is subsequently made, the main-memory restoring portion 1300 expands the content of the save area 2000, that is, only the content of the main memory after the initialization processing, to the main memory 103, and the system can be therefore activated at a higher speed than by the processing made by the initialization processing portion 104. The arrangement position of the save area 2000 is decided in accordance with the quantity of the content of the main memory after the initialization processing.

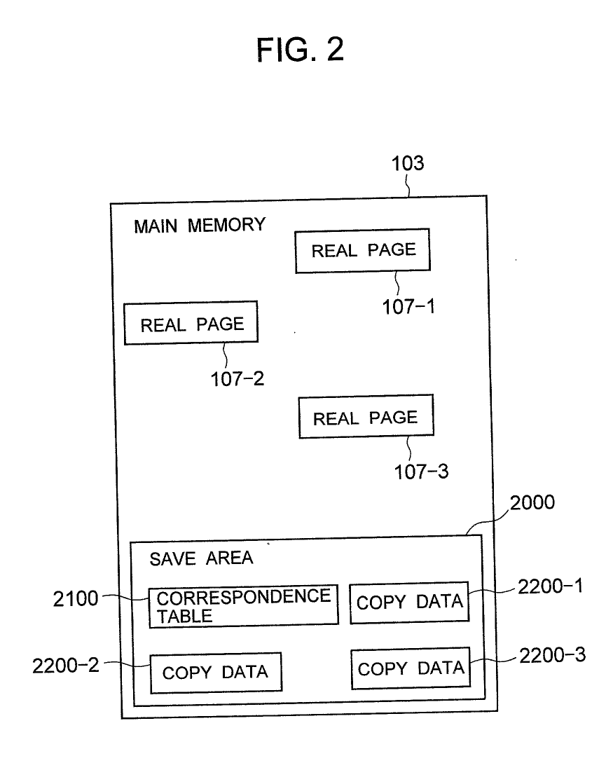

FIG. 2 is an explanatory view showing the construction of the save area 2000 and the outline of the processing for copying the main memory 103. The save area 2000 includes a correspondence table 2100 and copy data 2200. The main memory 103 has a plurality of real pages 107. The copy data 2200 is the one that copies the contents of these real pages 107. The correspondence table 2100 is an area that describes the correspondence of the real page 107 to the address of the copy data 2200.

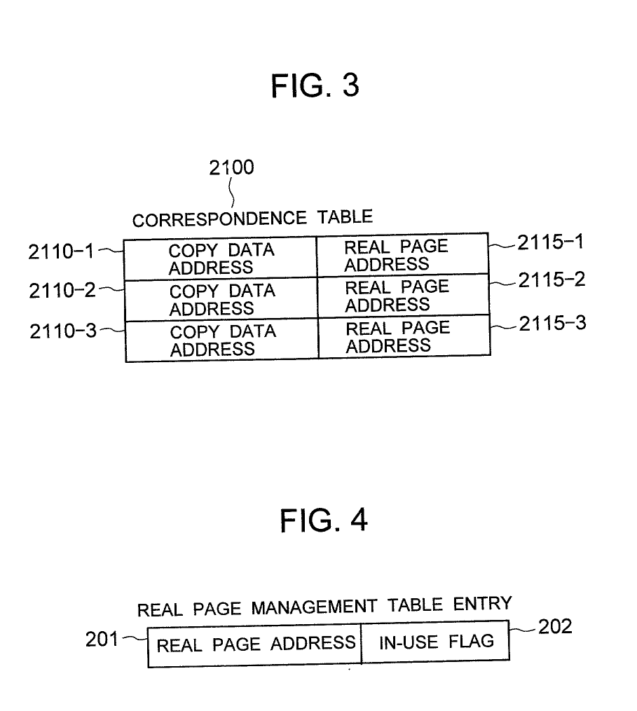

FIG. 3 is a structural view of the correspondence table 2100. A copy data address 2110 as a real address indicating the position of the copy data 2200 inside the save area 2000 in the main memory 103 and a real page address 2115 indicating the position of original content copied inside the main memory 103 form a set, and the same number of these sets as the number of real pages to be copied are described in the correspondence table.

The state after copying in this embodiment will be explained with reference to FIGS. 2 and 3.

Assuming that the real pages that are in use on the main memory 103 are three pages, that is, pages 107-1 to 107-3 as shown in FIG. 2, the contents of these three pages are copied to copy data 2200-1 to 2200-3, respectively. The real address of the copy data 2200-1 is described to the copy data address 2110-1 and the real address of the real page 107-1, to the real page address 2115-1, as shown in FIG. 3. The processing is executed similarly for other pages to constitute the correspondence table 2100.

FIG. 4 is a structural view of entry of the real page management table 200 used for judging whether or not the real page 107 on the main memory 103 is in use in this embodiment. In the real page management table 200, the entry shown in FIG. 4 is so arranged as to correspond to the real page 107 on the main memory 103. The real page address 201 stores the real address of the corresponding real page 107. An in-use flag 202 stores information indicating whether or not the real page 107 is in use. When the in-use flag 202 is ON, the real page 107 is in use and when the former is OFF, the latter is out of use.

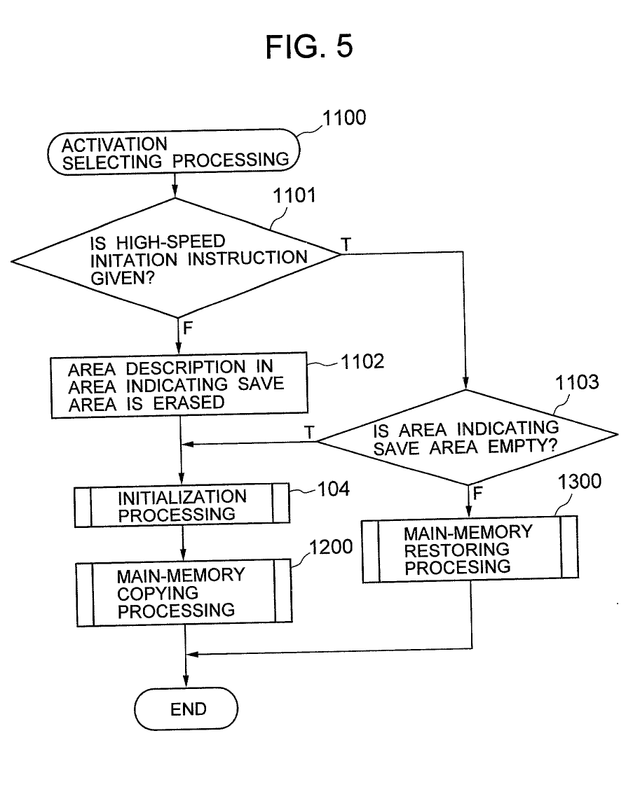

FIG. 5 is an explanatory view of the flow of the processing of the activation selecting portion 1100 in this embodiment. This processing is executed when a system activation instruction is given.

First, whether or not designation of activation from the SVP 105 is the designation that executes high-speed re-initiation is judged (Step 1101). When the judgment result of Step 1101 proves NO, the area indicating save area 300 is emptied (Step 1102). When the judgment result of Step 1102 proves YES, whether or not the area indicating save area 300 is empty is judged (Step 1103).

When the judgment result of Step 1103 is again YES after Step 1102, the processing of the initialization processing portion 104 is executed. Next, the processing of the main-memory copying portion 1200 is executed. When the judgment result of Step 1103 is NO, the processing of the main-memory restoring portion 1300 is executed.

The processing of the activation selecting portion 1100 is thus completed.

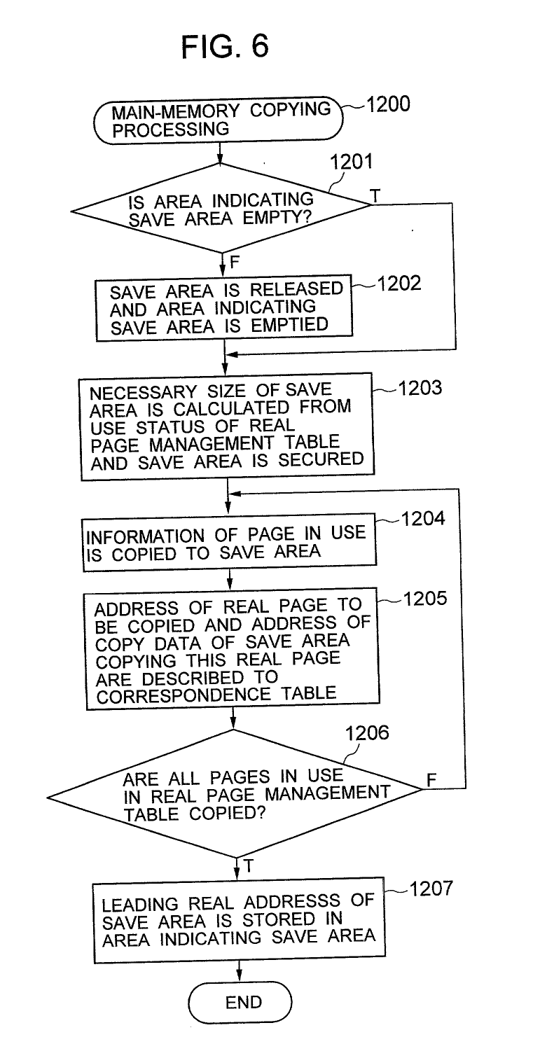

FIG. 6 is an explanatory view of the processing of the main-memory copying portion 1200 in this embodiment.

First, whether or not the area indicating save area 3000 is empty is judged (Step 1201). When the judgment result proves YES, the processing is as such continued. When the judgment result is NO, the existing save area 2000 is released and the area indicating save area 3000 is emptied (Step 1202). Next, the number of pages in use is acquired from the real page management table 200, and the pages are copied. The number of pages necessary for generating the correspondence table is computed and the save area is secured (Step 1203).

The content of the real page 107 the in-use flag 202 of which is ON inside the real page management table 200 is copied to the copy data 2200 (Step 1204). The real address of the original real page copied and the real address of the copy data 2200 after copying inside the save area 2000 are described to the correspondence table 2100 (Step 1205).

Next, whether or not all the real pages in the real page management table 200 the in-use flag 202 of which is ON other than the real page used in the save area 2000 are copied is judged (Step 1206). When the judgment result proves NO, the flow returns to Step 1204. When the judgment result is YES, the leading real address of the save area 2000 is stored in the area indicating save area 3000 (Step 1207).

The processing of the main-memory copying portion 1200 is thus completed.

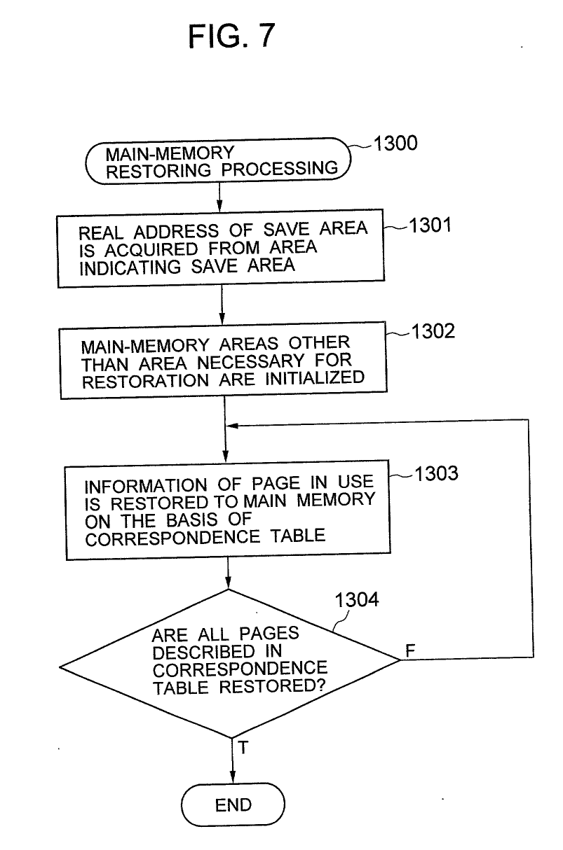

FIG. 7 is an explanatory view of the main-memory restoring portion 1300 in this embodiment.

First, the real address of the save area 2000 is acquired from the area indicating save area 3000 (Step 1301). The logic 0 is written into the real pages other than those of the area indicating save area 3000 necessary for the main-memory restoring processing and the area used for the save area 2000 to execute initialization (Step 1302).

The content of the copy data 2200 indicated by the copy data address 2110 is restored from the correspondence table 2100 inside the save area 2000 to the real page 107 indicated by the corresponding real page address 2115 (Step 1303).

Whether or not all the pages described in the correspondence table are restored is judged (Step 1304). When the judgment result proves NO, the flow returns to Step 1303. When the judgment result proves YES, the processing is as such completed.

Next, the second embodiment will be explained. This embodiment is fundamentally the same as the first embodiment, and the differences will be explained.

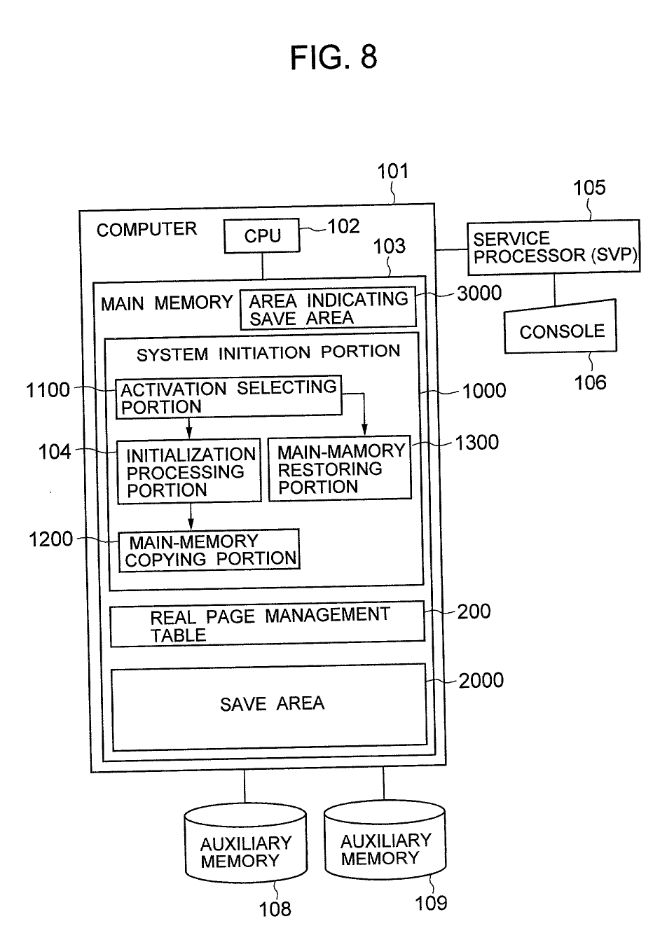

The computer system may employ a virtual memory management system. FIG. 8 is a basic structural view in this case. A computer 101 includes an auxiliary memory 108 for page saving in addition to a CPU 102 and a main memory 103. The computer 101 writes information that cannot be arranged any more on the main memory 103 to the auxiliary memory 108 and executes paging for reading, whenever necessary. In consequence, a virtual memory exceeding the capacity of the main memory 103 actually mounted can be expanded to the computer 101. The computer 101 includes also an auxiliary memory 109 for copying the content of the auxiliary memory 108 in the present invention.

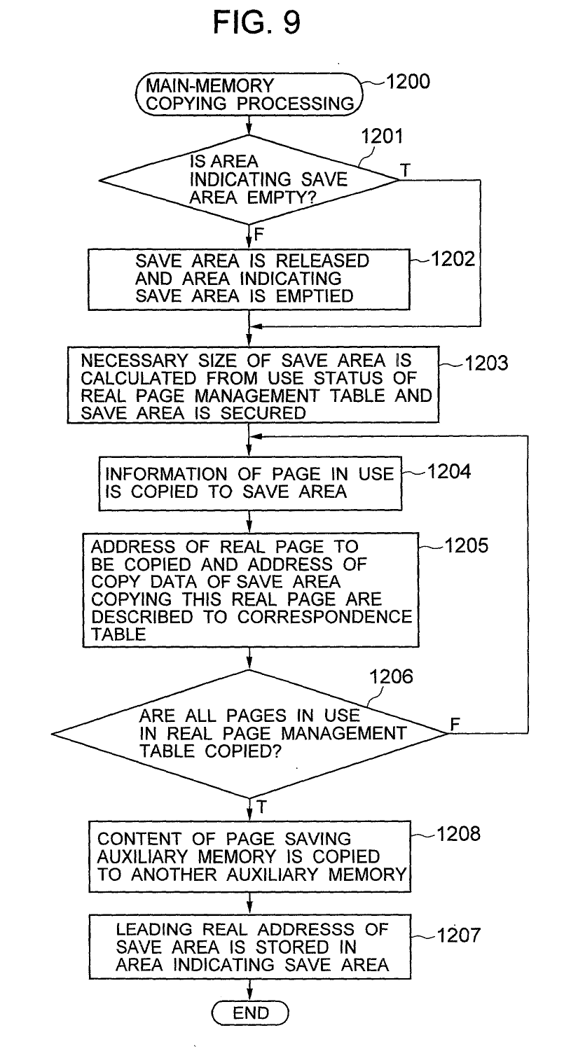

FIG. 9 is an explanatory view of the flow of a new main-memory copying portion 1200. Since the flow is fundamentally the same as the flow shown in FIG. 6, the difference will be explained.

This embodiment additionally includes Step 1208 for copying the content of the auxiliary memory 108 for page saving to the auxiliary memory 109 before the address of the save area 2000 is stored to the area indicating save area 3000 in Step 1207 after the content of the main memory 103 is copied to the save area 2000.

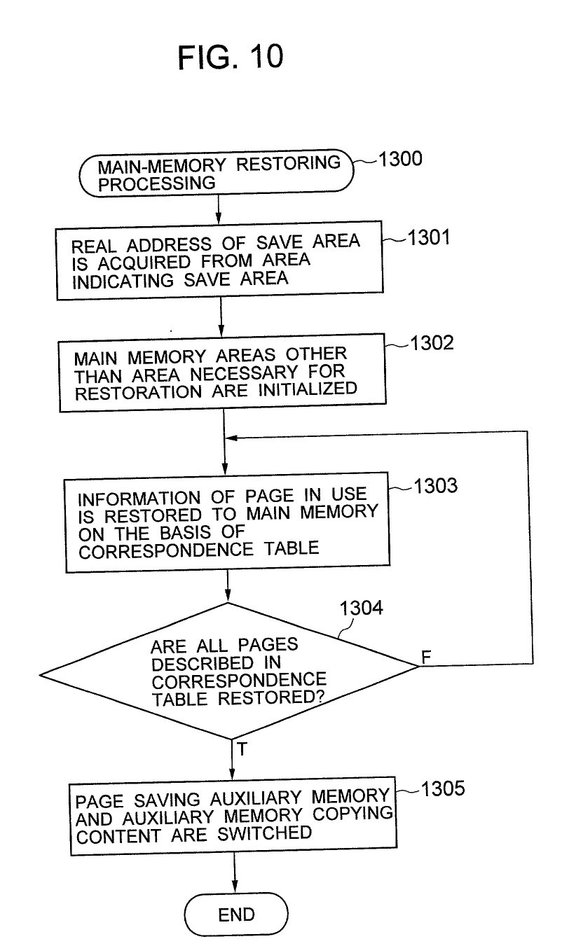

FIG. 10 is an explanatory view of the flow of a new main-memory restoring portion 1300. Since the flow is fundamentally the same as the flow shown in FIG. 7, the difference will be explained.

This embodiment additionally includes Step 1305 for switching the auxiliary memory 108 and the auxiliary memory 109 and using the auxiliary memory 109 as the auxiliary memory for page saving after the content of the save area 2000 is restored to the main memory 103.

The embodiments of the present invention have thus been explained, but the processing of the main-memory restoring portion 1200 may be executed at the point designated by the operator. In such a case, the processing of the main-memory copying portion 1200, that is executed after the processing of initial processing portion 104, is executed by the designation of the operator through the SVP 106.

Though the area indicating save area 3000 is secured to indicate the arrangement position of the save area 2000, the save area 2000 may be held by the SVP 105. Alternatively, an external memory may be provided to hold the save area 2000.

The present invention can initiate at a high speed the computer system by restoring the content of the main memory in use saved in the main memory after the system initiation to the main memory.

The present invention can limit the main memory capacity necessary for saving the content to the capacity of the main memory in use without relying on the capacity of the main memory mounted to the system.

It should be further understood by those skilled in the art that the foregoing description has been made on embodiments of the invention and that various changes and modifications may be made in the invention without departing from the spirit of the invention and the scope of the appended claims.

What is claimed is:

1. A method of re-initiating a computer system, comprising the steps of:
copying a content of an allocated area on an actual memory to a non-allocated save area on said actual memory after initiation of a computer system; and
associating an address of the copy origination area with an address of said copy destination area.

2. A method of re-initiating a computer system according to claim 1, further comprising the step of:
restoring the content of said save area on said real memory from said copy destination area to said copy origination area on the basis of said association at the time of re-initiation of said system.

3. A method of re-initiating a computer system using a virtual memory management system for arranging areas on a virtual memory to a real memory, comprising the steps of:
copying a content of an area on said real memory on which said areas of said virtual memory are arranged to a save area on said real memory on which said areas of said virtual memory are not arranged, after initiation of said computer system; and
associating an address of said copy origination area with an address of said copy destination area.

4. A method of re-initiating a computer system according to claim 3, further comprising the steps of:
restoring the content of said save area on said real memory from said copy destination area to said copy origination area on the basis of said association at the time of re-initiation of said system.

5. A method of re-initiating a computer system according to claim 3, wherein a content of a first memory holding the content of said area on said virtual memory not arranged on said area of said real memory is copied to a second memory.

6. A method of re-initiating a computer system according to claim 5, further comprising the step of:
exchanging and using said first memory and said second memory at the time of re-initiation of said system.

7. A method of re-initiating a computer system comprising the step of:
copying a content of an allocated area on a real memory to an non-allocated save area on said real memory after initiation of said computer system;
associating an address of said copy origination area with an address of said copy destination area; and
restoring the content of said save area on said real memory from said copy destination area to said copy origination area on the basis of said association at the time of re-initiation of said system.

8. A computer system including:
means for copying a content of an allocated area on a real memory to a non-allocated save area on said real memory after initiation of said system;
means for associating an address of a copy destination area with an address of a copy origination area; and
means for restoring the content of said save area on said real memory from said copy destination area to said copy origination area on the basis of said association at the time of re-initiation.
